(19) United States
(12) Patent Application Publication
(10) Pub. No.: US 2002/0181838 A1
(43) Pub. Date: Dec. 5, 2002

(54) Optical MEMS device and package having a light-transmissive opening or window

(76) Inventors: Shawn Jay Cunningham, Colorado Springs, CO (US); Dana Richard DeReus, Colorado Springs, CO (US); Victor Ramsey, Colorado Springs, CO (US)

Correspondence Address: JENKINS & WILSON, PA, 3100 TOWER BLVD, SUITE 1400, DURHAM, NC, 27707, US

(21) Appl. No.: 10/025,180

(22) Filed: Dec. 19, 2001

Related U.S. Application Data
(60) Provisional application No. 60/256,674, filed on Dec. 20, 2000.
(60) Provisional application No. 60/256,604, filed on Dec. 19, 2000.
(60) Provisional application No. 60/256,607, filed on Dec. 19, 2000.
(60) Provisional application No. 60/256,610, filed on Dec. 19, 2000.
(60) Provisional application No. 60/256,611, filed on Dec. 19, 2000.
(60) Provisional application No. 60/256,683, filed on Dec. 19, 2000.
(60) Provisional application No. 60/256,688, filed on Dec. 19, 2000.
(60) Provisional application No. 60/256,689, filed on Dec. 19, 2000.
(60) Provisional application No. 60/260,558, filed on Jan. 9, 2001.

(51) Int. Cl. G02B 6/35

(52) U.S. Cl. 385/16; 385/18

(57) ABSTRACT

An optical MEMS device and a package include an optical through path for allowing light to pass from a first side of the package, through a substrate on which the optical MEMS device is mounted and through a second side of the package opposite the first side. The package can include first and second light-transmissive portions or apertures for allowing the light to pass. The optical MEMS device can be a shutter for selectively affecting the flow of light through the package. A plurality of optical MEMS devices may be located within a single package because the optical paths for the MEMS devices can be substantially parallel to each other.

### RELATED APPLICATIONS

This application claims the benefit of U.S. provisional patent application no. 60/256,674 filed Dec. 20, 2000, U.S. provisional patent application no. 60/256,604 filed Dec. 19, 2000, U.S. provisional patent application No. 60/256,607 filed Dec. 19, 2000, U.S. provisional patent application No. 60/256,610 filed Dec. 19, 2000, U.S. provisional patent application No. 60/256,611 filed Dec. 19, 2000, U.S. provisional patent application No. 60/256,683 filed Dec. 19, 2000, U.S. provisional patent application No. 60/256,688 filed Dec. 19, 2000, U.S. provisional patent application No. 60/256,689 filed Dec. 19, 2000, and U.S. provisional patent application No. 60/260,558 filed Jan. 9, 2001, the disclosures of which are incorporated herein by reference in their entirety.

### TECHNICAL FIELD

The present invention relates to optical microelectromechanical systems (MEMS) devices. More particularly, the present invention relates to packaging for optical MEMS devices.

### BACKGROUND ART

MEMS are small scale devices, (e.g., devices ranging from about 1 micrometer in size to about 1 millimeter in size) that have functionality in physical domains outside of the integrated circuit world. For example, MEMS devices can perform solid mechanics, fluidics, optics, acoustics, magnetic, and other functions. The term MEMS, as used herein, also refers to devices and systems constructed using microfabrication technologies commonly used to make integrated circuits.

MEMS, like integrated circuits, are enclosed in packages, which connect the MEMS to external devices, such as printed circuit boards. The role of a package for an optical MEMS device is to provide the electrical, optical, and mechanical interface to the environment. A zero^{th} level package, as used herein, refers to a package that encapsulates an optical MEMS device at the wafer level or die level. A first level package, as used herein, refers to an optical MEMS device die that is assembled into an individual package. In the first level packaging case, the optical MEMS device does not require wafer level encapsulation. The electrical interface is provided by electrical leads of a first level package or by a wafer level electrical interface.

FIGS. 1A and 1B illustrate conventional first level packages. In FIG. 1A, package 100 includes a leaded chip carrier 102 and lid 104 for protecting an optical MEMS device 106 and a substrate 108. Wire bonds 110 connect pads on substrate 108 with external leads 112. External leads 112 connect package 100 with a printed circuit board.

An aperture or transmissive portion 114 in lid 104 allows optical communication between optical MEMS device 106 and external devices. For example, optical MEMS device 106 can reflect, respond electrically, respond thermally, or absorb light transmitted from external devices through aperture 114.

FIG. 1B illustrates another type of conventional packaging for optical MEMS devices. In FIG. 1B, packaging 116 includes a chip carrier 102 and a lid 104. An optical MEMS device 106 is mounted on a substrate 108. Electrical connections 118 extend through substrate 108 to electrically connect optical MEMS device 106 to external leads 120. Electrical leads 120 can be used to electrically connect optical MEMS device 106 to external devices.

In order to provide optical communication with external devices, lid 104 includes an aperture of transmissive portion 114. Aperture 114 communicates light from external devices to optical MEMS device 106 and from optical MEMS device 106 to external devices.

FIG. 1C illustrates yet another conventional packaging technology for optical MEMS devices. An example of this type of conventional packaging would be a multi-layer ceramic package with a molded cavity and a lid. In FIG. 1C, a package 122 includes a base portion 124 forming a cavity 126. An optical MEMS device 106 is mounted on a substrate 108 within cavity 126. Wire bond connections 110 electrically connect optical MEMS device 106 with external leads (not shown). In order to provide optical communications with external devices, package 122 includes a lid 104 having an aperture 114. External devices can communicate with optical MEMS device 106 through aperture 114. Optical MEMS device 106 can also reflect light through aperture 114. The lid 104 can be made of a solid piece of light transmissible material.

FIG. 1D illustrates yet another conventional packaging for an optical MEMS device. An example of this type of conventional packaging would be a molded cavity plastic package with a lid. In FIG. 1D, packaging 128 includes a base portion 130 forming a cavity 126. An optical MEMS device 106 is mounted on a substrate 108 within cavity 126. Through-chip electrical connections 118 electrically connect optical MEMS device 106 with external leads 132. External leads 132 electrically interface optical MEMS device 106 with an external device, such as a printed circuit board.

In order to communicate optically with external devices, a lid 104 includes an aperture 114. Light from external devices can communicate with optical MEMS device 106 through aperture 114. Optical MEMS device 106 can also reflect light through aperture 114. The lid 104 can be made of a solid piece of light transmissible material.

In all of the examples illustrated in FIGS. 1A-1D, a light source 134 is positioned at a first angle with respect to aperture 114, and a detector 136 is positioned at a second angle with respect to aperture 114. Light emitted from light source 134 passes through aperture 114 and impacts optical MEMS device 106. Optical MEMS device 106 selectively reflects the light to detector 136. Thus, in the configurations illustrated in FIGS. 1A-1D, light source 134 and detector 136 must be located on the same side of optical MEMS device 106. In addition, light source 134 and detector 136 must be located at a predetermined angle with regard to aperture 114 and optical MEMS device 106. Requiring such precise alignment between a light source, an optical MEMS device, and a detector decreases the flexibility in designing systems that include optical MEMS devices and increases manufacturing costs of such systems.

In order to provide increased flexibility in aligning an optical MEMS device with regard to external devices, some optical MEMS devices include complex waveguides to guide light from external devices to an optical MEMS device. FIG. 1E illustrates an example of a conventional optical MEMS device that includes complex waveguides for guiding light to internal actuators. In FIG. 1E, optical MEMS device 150 includes a first substrate 152 and a second substrate 154. Substrate 152 includes a plurality of bonding sites 156, and substrate 154 includes a plurality of corresponding bonding sites 158. When surface 160 of substrate 152 is mated with surface 162 substrate 154, bonding sites 156 contact bonding sites 158. Substrate 152 includes an optical demultiplexer 164 and an optical multiplexer 166. Optical multiplexer 164 includes a plurality of waveguides 168A-168D and optical multiplexer 166 includes a plurality of corresponding waveguides 170A-170D. In order to communicate with external devices, optical demultiplexer 164 includes an input/output waveguide 172. Similarly, optical multiplexer 166 includes an input/output waveguide 174.

In order to selectively connect and disconnect waveguides 168A-168D with waveguides 170A-170D, substrate 154 includes a plurality of MEMS actuators 176A-176D. Each actuator 176A-176D includes an optical interrupter 178A-178D for interrupting optical paths between waveguides 168A-168D and 170A-170D.

In operation, light enters optical MEMS device 150 through waveguide 172. Waveguide 172 guides the light to optical demultiplexer 164. Interrupters 178A-178D selectively allow light to pass from waveguides 168A-168D to waveguides 170A-170D. Optical multiplexer 166 merges the stream of light and outputs the light through waveguide 174.

Requiring such a complex arrangement of waveguides to guide light from an external source to an optical MEMS device increases the time and expense for manufacturing optical MEMS devices. For example, forming waveguides such as those illustrated in FIG. 1E involves complex etching, masking, and depositing of materials on a substrate. For some optical waveguides, both core and cladding materials must be deposited on the substrate. Requiring such operations greatly increases the costs of fabricating optical MEMS devices.

Accordingly, in light of the alignment problems discussed above with respect to optical MEMS devices having a single aperture and in light of the manufacturing problems associated with optical MEMS devices that require waveguides, there exists a need for improved methods and systems for packaging optical MEMS devices that avoids at least some of the difficulties associated with conventional optical MEMS devices and packaging technologies.

Disclosure of the Invention

The present invention includes a light-transmissive optical MEMS device and package having light-transmissive portions on both sides of the optical MEMS device such that light can pass through one side of the package, through the optical MEMS device, and out the other side of the package. Providing an optical MEMS device and a package that allow light to pass through the package and the optical MEMS device avoids the alignment problems associated with conventional optical MEMS devices without adding the manufacturing problems associated with waveguide based optical MEMS devices.

Accordingly, it is an object of the invention to provide an optical MEMS device and packaging for an optical MEMS device that allow light to pass through one side of the packaging, through the substrate containing the optical MEMS device, and out the other side of the packaging.

An object of the invention having been stated hereinabove and which is achieved in whole or in part by the present invention, other objects will become evident as the description proceeds when taken in connection with the accompanying drawings as best described hereinbelow.

### BRIEF DESCRIPTION OF THE DRAWINGS

FIGS. 1A-1D are sectional views of conventional packaging for optical MEMS devices;

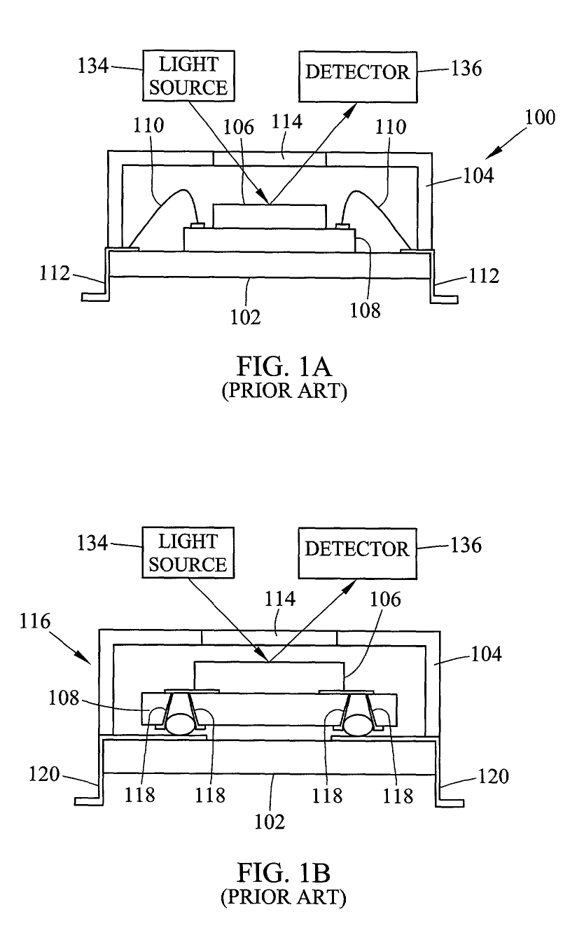

FIG. 1E is a perspective view of a conventional waveguide-based optical MEMS device;

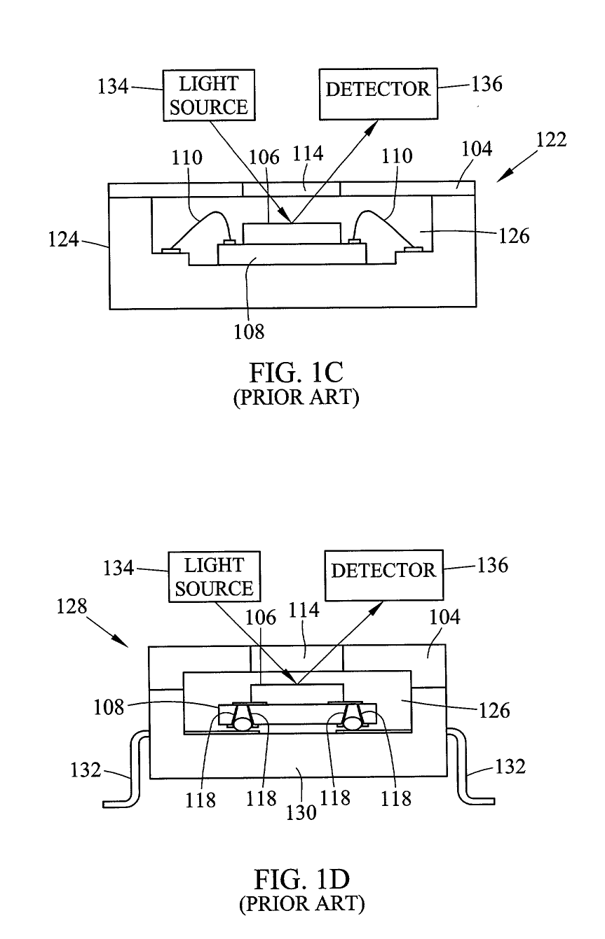

FIGS. 2A-2D are sectional views of optical MEMS devices mounted on light-transmissive substrates according to embodiments of the present invention;

FIGS. 3A-3C are sectional views illustrating packaging and optical MEMS devices that allow communication of optical information through the packaging and the optical MEMS devices according to embodiments of the present invention;

FIG. 4 is a sectional view of an optical MEMS device including anti-reflective coatings according to an embodiment of the present invention; and

FIG. 5 is a top plan view of a quad flat pack package including an optical aperture defined in the package base according to an embodiment of the present invention.

### DETAILED DESCRIPTION OF THE INVENTION

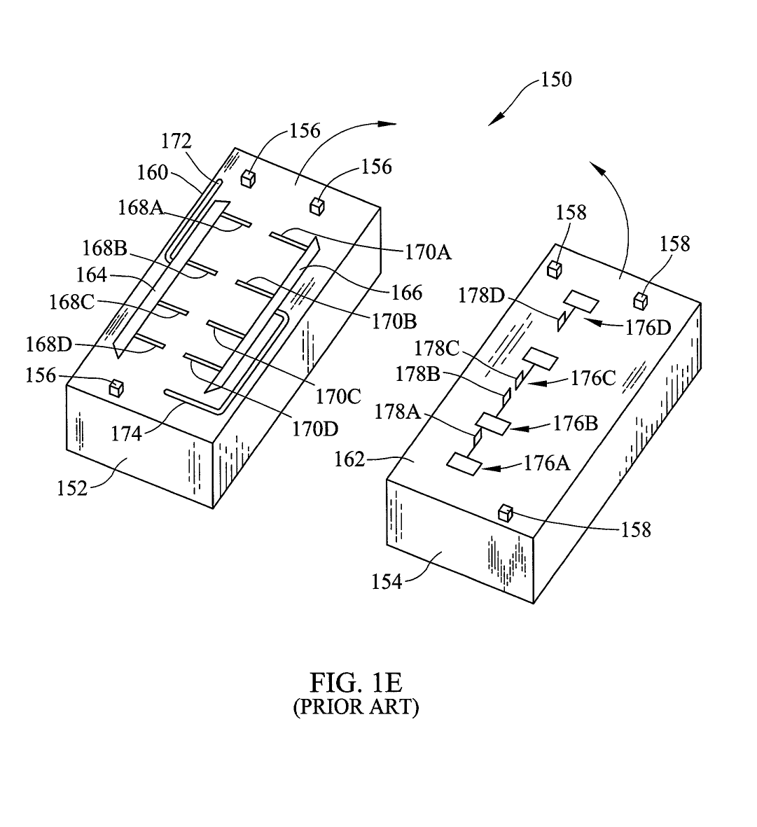

FIGS. 2A-2D illustrate optical MEMS devices mounted on light-transmissive substrates according to embodiments of the present invention. More particularly, FIGS. 2A and 2B illustrate optical MEMS devices without protective lids or enclosures and FIGS. 2C and 2D illustrate optical MEMS devices with protective lids or enclosures. Referring to FIG. 2A, an optical MEMS device 200 is mounted on a light-transmissive substrate 202. Optical MEMS device 200 can be any suitable optical MEMS device for blocking, reflecting, altering, modulating, or otherwise changing light as the light passes from one side of substrate 202 to the other side of substrate 202. Exemplary optical MEMS devices suitable for use with embodiments of the present invention include piezoelectric shutters, electrostatic shutters, bimetallic thermal shutters, or any other type of device that modulates light as it passes through substrate 202.

Light-transmissive substrate 202 can be any type of substrate that allows light to pass at predetermined operational frequencies. The particular material from which substrate 202 can be formed depends on the frequencies of light desired to be passed. For example, if it is desirable to pass light in the infrared range of frequencies, substrate 202 can be made of silicon. If it is desirable to pass light in the visible range, substrate 202 can be made of glass. In any case of a light transmissive substrate 202, an antireflective coating may be applied to the surfaces of 202 that are designed to match the substrate material and the wavelength of light. Another form of light transmissive substrate 202 would include a substrate with an optical aperture. The aperture would be required in substrate 202 when the appropriate light transmissive material cannot be identified or is not appropriate for the particular manufacturing methods.

In FIG. 2A, through-wafer electrical connections 203 are provided to connect pads 204 to leads of a chip carrier (not shown). In FIG. 2B, wire bonds (not shown) can be used to connect pads 204 to external electrical leads. The electrical connections for a light transmissive substrate 202 according to the invention are not limited to through-wafer electrical connections or the wire bond connections.

In FIGS. 2C and 2D, transmissive lids 206 are mounted on substrates 202 to protect optical MEMS devices 200 from the external environment. Substrates 202 and lids 206 can be formed of any suitable material that is transmissive at wavelengths used by optical MEMS device 200. Exemplary materials suitable for use in forming substrates 202 and lids 206 include glass, silicon, or other materials, depending on the frequencies of light desired to be passed. In any case of a light transmissive lid 206, an antireflective coating may be applied to the surfaces of 206 that are designed to match the lid material, the optical properties of the external environment, and the wavelength of light. Another form of light transmissive lid 206 would include a lid with an optical aperture. The aperture would be required in lid 206 when the appropriate light transmissive material cannot be identified or is not appropriate for the particular manufacturing methods.

In operation, because substrates 202 illustrated in FIGS. 2A-2D are light-transmissive, light can pass from one side of substrates 202 to the other side of substrates 202. Optical MEMS devices 200 can selectively affect, e.g., interrupt, reflect, redirect, filter, or otherwise interact with, the flow of light to perform a desired signaling function, such as switching. Because light passes through the substrate, external devices, such as light sources and detectors, can be mounted on either or both sides of substrates 202 without the alignment problems associated with conventional optical MEMS devices. In addition, because substrates 202 and lids 206 are preferably light-transmissive in both directions, the flow of light through lid 206 and substrate 202 is reversible.

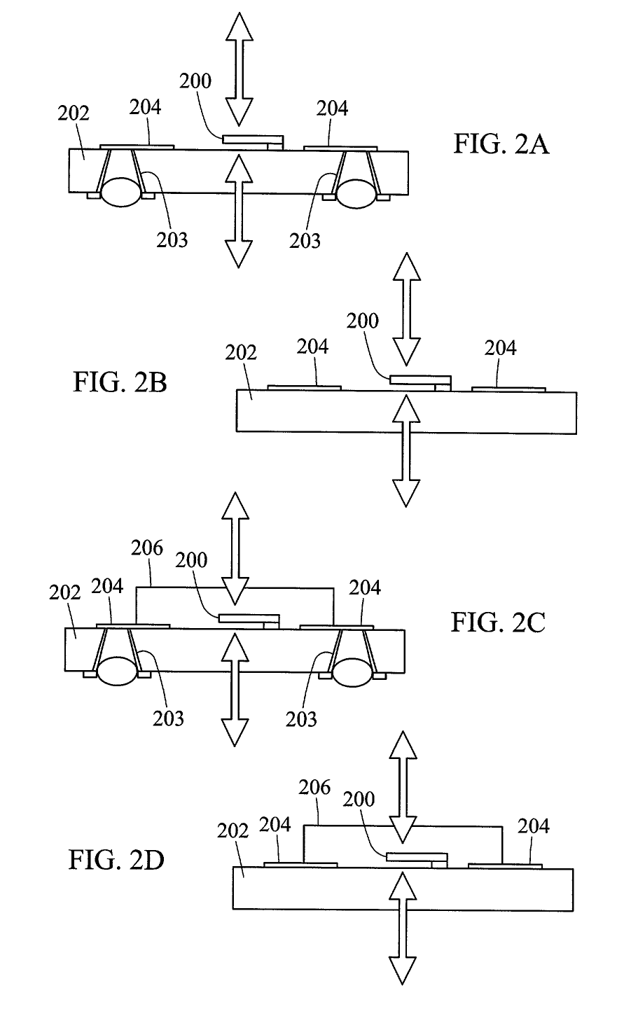

FIGS. 3A-3C illustrate optical MEMS devices and packaging including optical pass throughs or apertures according to embodiments of the present invention. Referring to FIG. 3A, optical MEMS device 200, transmissive substrate 202, and transmissive lid 206 are mounted on package 300. Package 300 includes a base portion 302 having an aperture 304. Electrical leads 306 of package 300 can be bonded to electrical leads 203 of optical MEMS device 200 using any suitable bonding technique, such as solder bonding, solvent bonding, or any other method for bonding leads 203 to pads 306 in an electrically-conductive manner. A lid 104 having a light-transmissive portion or aperture 114 can be bonded to base portion 302 to further protect optical MEMS device 200 and substrate 202 from the external environment. Substrate 202 can also be bonded to base portion 202 to hermetically seal optical MEMS device within package 300. In some applications, the seal is not required to form a hermetic seal. Exemplary bonding methods for bonding substrate 202 to base portion 302 include solvent bonding or adhesive bonding. For example, in the embodiment illustrated in FIG. 3A, a ring of bonding adhesive 308 can be placed on the surface of base portion 302 prior to mounting substrate 202 on base portion 302. The bonding adhesive is preferably non-conductive to avoid short circuiting adjacent electrical leads 306.

Transmissive lid 206, transmissive substrate 202, and apertures 304 and 114 form an optical pass through for allowing light to pass from one side of package 300 to the other side of package 300. Providing such optical pass through capability allows external devices to communicate with optical MEMS device 200 from either or both sides. The optical path through the lid, the substrate, and the chip carrier is completely reversible. Accordingly, the design complexity of optical systems that utilize the embodiment illustrated in FIG. 3A can be reduced.

FIG. 3B illustrates a first level package and an optical MEMS device having an optical through path according to another embodiment of the present invention. In FIG. 3B, package 310 includes a base portion 312 having an upper aperture 314 and a lower aperture 316. In the illustrated example, apertures 314 and 316 are respectively sealed by light-transmissive members and 320. Light-transmissive members 318 and 320 can be made of any material suitable for passing light at frequencies of interest. Because light-transmissive member 320 is preferably sealingly connected to base portion 312, an additional sealing ring, such as ring 308 in FIG. 3A might not be required.

Package 310 includes external electrical leads 322 for electrically connecting optical MEMS device 200 to external devices. Electrical leads 322 are preferably bonded to leads 203 of substrate 202, e.g., using solder bonding.

According to an important aspect of the invention, light-transmissive members 318 and 320, lid 206, and substrate 202 allow light to pass from one side of substrate 202 to an opposite side of substrate 202. Accordingly, detectors and light sources can be located on either or both sides of a package 310 without the alignment problems associated with conventional optical MEMS devices.

FIG. 3C illustrates another embodiment of a package and an optical MEMS device with an optical through path according to an embodiment of the present invention. In FIG. 3C, package 324 includes a body 326 having first and second apertures 328 and 330. Apertures 328 and 330 can be open or covered with light-transmissive covers. If apertures 328 and 330 are open, package 326 is preferably sealingly connected to lid 206 and substrate 202 to reduce the likelihood of contamination of optical MEMS device 200. Package 326 includes electrical leads 332 for interfacing with external devices. Leads 332 are preferably bonded to electrical connections 203 of substrate 202. Because apertures 328 and 330 are located on opposite sides of substrate 202, light can pass through aperture 364, substrate 202, optical MEMS device 200, and transmissive lid 206 in either direction.

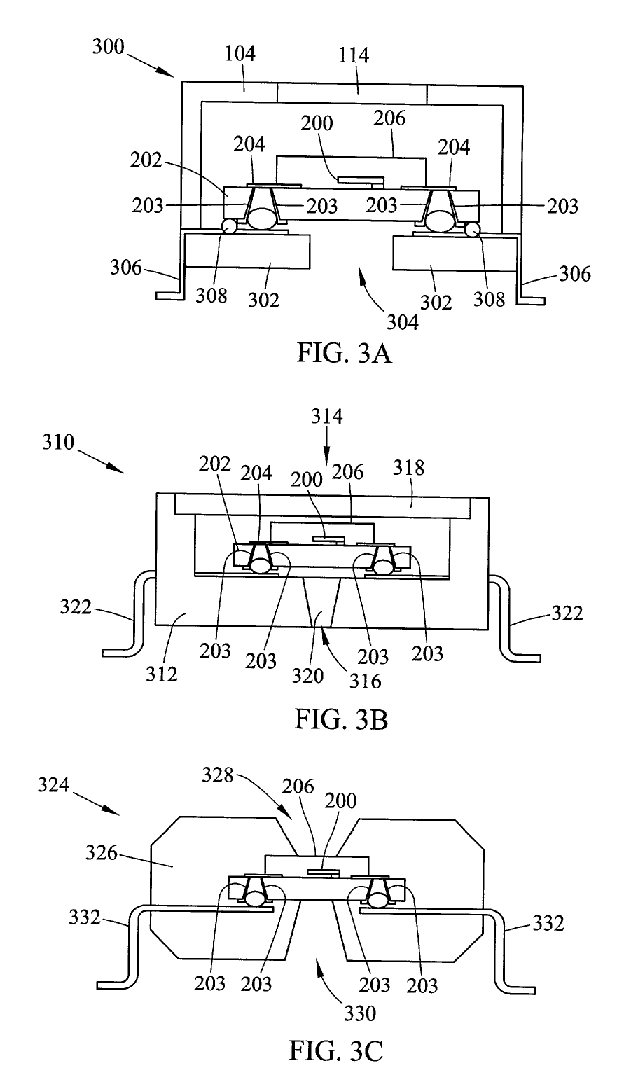

FIG. 4 illustrates another embodiment of the present invention having transmissive lids on opposite sides of substrate 202 with anti-reflective coatings on surfaces of the transmissive lids. Referring to FIG. 4, package 400 includes a base portion 402 forming a cavity 404 in which optical MEMS device 200 and substrate 202 are located. Electrical leads 406 electrically connect optical MEMS device 200 with external devices. Electrical leads 406 are preferably bonded to leads 203 of substrate 202. In the illustrated example, packaging 400 includes a first light-transmissive member 408 located on one side of substrate 202 and a second light-transmissive member 410 located on an opposing side of substrate 202. Members 408 and 410 can be made of glass, silicon, or other material, depending on the wavelength of light desired to be passed. Members 408 and 410 are preferably sealingly connected to packaging 400 to protect optical MEMS device 200. Base portion 402 includes an aperture 412 to allow optical communication through base portion 402.

In order to reduce internal and external reflections, all surfaces in the optical path are preferably coated with an anti-reflective coating. The particular anti-reflective coating depends o the wavelength of light desired to be passed. In one example, the anti-reflective coating can be a single layer anti-reflective coating having a thickness is given by

$${n}_{f} {d}_{f} = \frac{λ}{4} ,$$

where n_{f} is the film index of refraction, d_{f} is the film thickness, and λ is the wavelength of the incident light. The ideal index of refraction of the film can be determined by n_{f}=\sqrt{n₁n₂}, where n_{f}n₁, and n₂ are the indices of refraction for the anti-reflective film, and the bounding media, respectively. For a single layer film on silicon, experiments have shown that low losses occur through a 190 nm Si₃N₄ film at a center wavelength of approximately 1574 nm. If lid 106 is made of glass, magnesium fluoride (MgF₂) and Cryolite™ are possible candidates for anti-reflective coatings. In the illustrated embodiment, anti-reflective coatings are preferably provided on surfaces 414 of member 408, surfaces 416 of substrate 202, and surfaces 418 of member 410. Providing anti-reflective coating on each of the aforementioned surfaces increases the optical efficiency of system illustrated in FIG. 4. In another example, the antireflective coating would have multiple layers, with various ratios of the refractive index and the thickness.

In FIG. 4, a first light source/detector 418 can be located on a first side of package 400 and a second light source/detector 420 can be located on a second side of package 400. Light sources/detectors 418 and 420 can each include light emitting elements, such as diodes, and light detecting elements, such as phototransistors. In the illustrated example, light source/detector 420 is mounted on the opposite side of a printed circuit board 422 from the side on which package 400 is mounted. Printed circuit board 422 can include an aperture 422 located under package 400 to allow optical communication between light source/detector 420 and optical MEMS device 200. Light source detector 418 can be located on another printed circuit board (not shown) that opposes printed circuit board 422.

In operation, light source/detector 418 can communicate with light source/detector 420 through package 400. More particularly, light emitted from light source detector 418 can travel through transmissive member 408 and into cavity 404. In cavity 404, optical MEMS device 200 selectively affects the flow of light from light source/detector 418. Light that is allowed to pass goes through substrate 202, through aperture 412, through light-transmissive member 410, through aperture 424 and to light source/detector 420. Communication can also occur in the opposite direction, i.e., from light source/detector 420 through package 400 and to light source/detector 418.

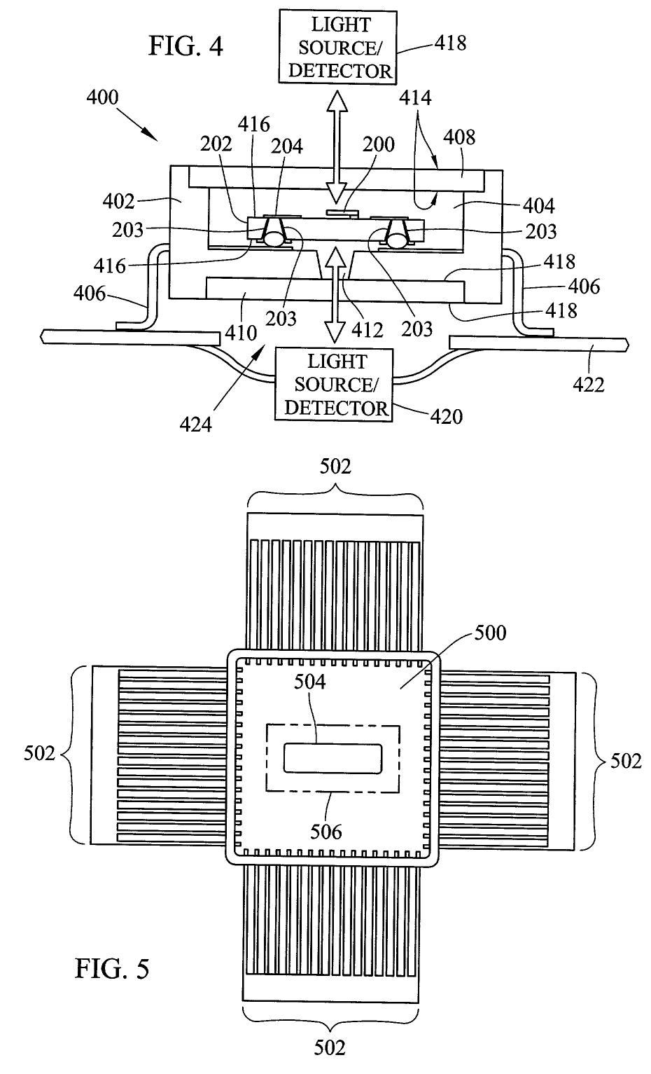

FIG. 5 is a top plan view of a quad flat pack package base suitable for use with a through-wafer optical shutter array according to an embodiment of the present invention. In FIG. 5, a package 500 includes a plurality of electrical leads 502 for communicating electrically with external devices. According to an important aspect of the present invention, package 500 includes an aperture 504 for allowing optical communication through its base. A substrate for an optical MEMS device can be mounted in the area indicated by dashed lines 506. Optical MEMS device, such as an optical shutter array can be mounted on substrate. The optical MEMS device can be encapsulated within a transmissive optical material or covered with a transmissive lid, as previously described.

Thus, the present invention provides an optical through path through an optical MEMS package and through a substrate on which an optical MEMS device is mounted. Light sources/detectors can thus bidirectionally communicate with each other through the optical MEMS device package and through the substrate. As a result of this through-device communication capability, alignment and fabrication problems associated with conventional optical MEMS devices are reduced.

Although the embodiments described above show a single optical MEMS device located within a package, the present invention is not intended to be limited to single-device packages. The optical through path design of the present invention is easily scalable to multiple devices because optical paths of adjacent optical MEMS devices are parallel to each other and thus do not interfere with each other. As a result, a higher density of optical MEMS devices can be placed within a single package than conventional designs that require light sources, detectors, and optical MEMS devices to be offset from each other.

It will be understood that various details of the invention can be changed without departing from the scope of the invention. Furthermore, the foregoing description is for the purpose of illustration only, and not for the purpose of limitation—the invention being defined by the claims.

What is claimed is:

1. An optical microelectromechanical system having an optical through path, the system comprising:
(a) a light-transmissive substrate having a first side and a second side opposite the first side;
(b) an optical MEMS device mounted on the first side of the substrate for selectively affecting optical signals transmitted through at least one of the first and second sides of the substrate; and
(c) a package for enclosing the optical MEMS device and the substrate, the package including a first light-transmissive portion for communicating light between the first side of the substrate and external devices located on the first side of the substrate and a second light-transmissive portion for communicating light between the second side of the substrate and external devices located on the second side of the substrate.

2. The system of claim 1 wherein the substrate is light-transmissive at predetermined optical frequencies.

3. The system of claim 2 wherein the substrate is light-transmissive at frequencies in the infrared range.

4. The system of claim 2 wherein the substrate is light-transmissive at frequencies in the visible range.

5. The system of claim 3 wherein the substrate comprises a silicon material.

6. The system of claim 4 wherein the substrate comprises a glass material.

7. The system of claim 1 wherein the optical MEMS device comprises a shutter.

8. The system of claim 7 wherein the shutter includes a piezoelectric actuator.

9. The system of claim 7 wherein the shutter includes a magnetic actuator.

10. The system of claim 7 wherein the shutter includes a thermal actuator.

11. The system of claim 7 wherein the shutter includes an electrostatic actuator.

12. The system of claim 1 wherein the package comprises a zero^{th} level package.

13. The system of claim 1 wherein the package comprises a first level package.

14. The system of claim 1 wherein at least one of the first and second light-transmissive portions comprises an aperture.

15. The system of claim 1 wherein at least one of the first and second light-transmissive portions comprises a light-transmissive material.

16. The system of claim 1 wherein the package includes a base portion and having an aperture and the substrate is sealingly connected to the base portion over the aperture.

17. The system of claim 1 comprising an antireflective film located on surfaces of the substrate and the package in the optical through path.

18. The system of claim 1 comprising a plurality of optical MEMS devices located inside the package having optical communication paths through the package that are substantially parallel to each other.

19. A package for an optical MEMS device, the package comprising:
(a) a base portion having a first surface for receiving an optical MEMS device and a substrate;
(b) a plurality of electrical leads connected to the base portion for electrically connecting an optical MEMS device to external devices; and
(c) a light-transmissive portion located in the base portion for allowing light to pass through the first surface to a second surface of the base portion opposite the first surface.

20. The package of claim 19 wherein the base portion is substantially flat.

21. The package of claim 19 wherein the base portion includes a cavity for receiving the optical MEMS device and the substrate.

22. The package of claim 19 wherein the electrical leads comprise surface mount leads.

23. The package of claim 19 wherein the electrical leads comprise pin-through-hole leads.

24. The package of claim 19 wherein light-transmissive portion comprises an aperture.

25. The package of claim 19 wherein the light-transmissive portion comprises a light-transmissive material.

26. The package of claim 25 wherein the light-transmissive material is adapted to pass predetermined frequencies of light.

27. The package of claim 26 wherein the light-transmissive material is adapted to pass frequencies of light in the visible range.

28. The package of claim 26 wherein the light-transmissive material is adapted to pass frequencies of light in the infrared range.

29. The package of claim 27 wherein the light-transmissive material comprises glass.

30. The package of claim 28 wherein the light-transmissive material comprises silicon.

31. The package of claim 19 comprising a lid including a light-transmissive portion for sealingly connecting to the base portion and for allowing light to pass through the light-transmissive portion in the base portion.

32. A microelectromechanical communications system, the system comprising:
(a) an optical MEMS device;
(b) a first light source/detector located on a first side of the optical MEMS device;
(c) a second light source/detector located on a second side of the optical MEMS device, the second side being opposite the first side;
(d) a package for enclosing the optical MEMS device, the package including a first light-transmissive portion located on the first side of the optical MEMS device and a second light-transmissive portion located on the second side of the optical MEMS device, the first and second light-transmissive portions forming an optical through path for bidirectional communications between the first and second light sources/detectors.

33. The system of claim 32 wherein the optical MEMS device comprises a shutter.

34. The system of claim 32 wherein at least one of the light sources/detectors includes a diode.

35. The system of claim 32 wherein at least one of the light sources/detectors includes a phototransistor.

36. The system of claim 32 comprising a first printed circuit board having an aperture, wherein the package is locate on a first surface of the first printed circuit board over the aperture and the first light source/detector is located on a second surface of the printed circuit board opposite the first surface and proximal to the aperture.

37. The system of claim 36 comprising a second printed circuit board including a first surface opposing the first surface of the first printed circuit board wherein the second light source/detector is located on the first surface of the second printed circuit board.

38. A method for communicating between a first optical device and a second optical device using an optical MEMS device and a package having an optical through path, the method comprising:
(a) emitting light from a first optical device located on a first side of a package containing an optical MEMS device;
(b) passing the light through a first surface located on a first side of the package;
(c) selectively affecting the flow of light within the package using the optical MEMS device; and
(d) passing light from the package through a second surface of the package located on a second side of the package opposite the first side to a second optical device located on the second side of the package.

39. The method of claim 38 wherein emitting light from a first optical device include emitting infrared light from the first optical device.

40. The method of claim 38 wherein emitting light from a first optical device includes emitting visible light from the first optical device.

41. The method of claim 38 wherein passing light through a first surface of the package includes passing light through an aperture located in the first surface of the package.

42. The method of claim 38 wherein passing light through a first surface of the package includes passing light through a light-transmissive portion in the first surface of the package.

43. The method of claim 38 wherein selectively affecting the flow of light inside the package includes selectively blocking the flow of light through the package.

44. The method of claim 38 wherein passing light through a second surface of the package includes passing light through an aperture located in the second surface.

45. The method of claim 38 wherein passing light through a second surface of the package includes passing light through a light-transmissive portion in the second surface.
